(19) United States
(12) Patent Application Publication
(10) Pub. No.: US 2004/0194143 A1
(43) Pub. Date: Sep. 30, 2004

(54) Video selection server, video delivery system, and video selection method

(76) Inventor: Tomonori Hirose, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/771,697

(22) Filed: Feb. 4, 2004

(30) Foreign Application Priority Data
Mar. 24, 2003 (JP) 2003-080180

(51) Int. Cl. H04N 7/173

(52) U.S. Cl. 725/97; 725/96

(57) ABSTRACT

A video selection server for preventing delivery of unnecessary video streams over a network. A receiving unit receives a video stream delivered via a first network, and an information analysis unit analyzes information about the video stream received by the receiving unit. A decision unit determines whether or not the result of analysis by the information analysis unit fulfills a predetermined criterion, to judge whether to permit delivery of the video stream received by the receiving unit to a second network. A transmitting unit transmits, to the second network, the video stream of which the delivery to the second network has been permitted by the decision unit.

### BACKGROUND OF THE INVENTION

(1) Field of the Invention

The present invention relates to a video selection server, video delivery system and video selection method for selectively relaying video information, and more particularly, to a video selection server, video delivery system and video selection method for relaying video streams between networks in different environments.

(2) Description of the Related Art

With the advance of information communication technology, data transmission speed is becoming faster and faster, permitting motion pictures to be delivered via a network by using IP (Internet Protocol) techniques etc. For example, a system has been contrived wherein image data captured by CCD (Charge-Coupled Device) cameras etc. is delivered in real time by unicast or multicast. Use of such a system makes it possible for images captured by security cameras to be transmitted over a network and viewed at a monitoring center.

When delivering motion picture data in real time, captured images are generally once stored in a storage device within a server. The stored images are then compressed (encoded) and transmitted onto a network as IP packets etc.

The data transferred in this manner, however, involves a delay corresponding to the processes for storing images and retrieving the stored images. In the case of video content whose real-timeliness or simultaneity is of especial importance (such as live sportscasting or video from surveillance cameras), for example, the image delivery delay time should desirably be shortened. In view of this, techniques have been proposed whereby image information is compressed/encoded and assembled into packets without being temporarily stored, to be transmitted to multiple clients by multicast (see Japanese Unexamined Patent Publication No. 2001-245281, for example).

In the case of multicasting a video stream by conventional techniques, however, whether to deliver or not can be selected only at the source (e.g., encoder) of delivery of the video stream. Once a video stream is multicast, the stream is transmitted over networks. Even if it is judged at a client that the video should not be reproduced and thus the client does not receive the video stream, the multicast video stream is not blocked anywhere in the middle of the transmission path from the encoder to the client. Consequently, when video streams are multicast in real time, useless video streams often flow to network, consuming more transmission bandwidth than necessary.

Moreover, where a video stream is delivered by multicast, not all transmission paths can transmit the data at the same rate. If a video stream of low image quality suited to low-rate transmission paths is delivered, then it is not possible to provide satisfactory services to the users of clients connected to high-rate transmission paths. Conversely, if a video stream of high image quality suited to high-rate transmission paths is delivered, it is difficult for clients connected to low-rate transmission paths to smoothly reproduce the video. If video streams of both high and low image qualities are delivered by broadcast, consumption of the traffic increases.

### SUMMARY OF THE INVENTION

The present invention was created in view of the above circumstances, and an object thereof is to provide a video selection server, video delivery system and video selection method capable of restraining delivery of unnecessary video streams over a network.

To achieve the object, there is provided a video selection server for selectively relaying video information. The video selection server comprises a receiving unit for receiving a video stream delivered via a first network, an information analysis unit for analyzing information about the video stream received by the receiving unit, a decision unit for determining whether or not a result of analysis by the information analysis unit fulfills a predetermined criterion, to judge whether to permit delivery of the video stream received by the receiving unit to a second network, and a transmitting unit for transmitting, to the second network, the video stream of which the delivery to the second network has been permitted by the decision unit.

Also, to achieve the above object, there is provided a video delivery system for delivering a video stream. The video delivery system comprises an encoder for encoding captured video to obtain a video stream and delivering the video stream via a first network, and a video selection server for receiving the video stream delivered via the first network, analyzing information about the received video stream, determining whether or not a result of the analysis fulfills a predetermined criterion, to judge whether to permit delivery of the received video stream to a second network, and transmitting, to the second network, the video stream of which the delivery to the second network has been permitted.

Further, to achieve the above object, there is provided a video selection method for selectively relaying video information. The video selection method comprises the step of receiving a video stream delivered via a first network, the step of analyzing information about the received video stream, the step of determining whether or not a result of the analysis fulfills a predetermined criterion, to judge whether to permit delivery of the received video stream to a second network, and the step of transmitting, to the second network, the video stream of which the delivery to the second network has been permitted.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram illustrating the invention applied to embodiments;

FIG. 2 is a diagram showing an exemplary configuration of a video selection server;

FIG. 3 is a diagram showing an example of how video streams are transferred via the video selection server;

FIG. 4 is a diagram showing an exemplary hardware configuration of the video selection server used in the embodiments of the present invention;

FIG. 5 is a conceptual diagram illustrating the manner of separating a video stream;

FIG. 6 is a diagram showing an example of how information is delivered via the video selection server;

FIG. 7 is a diagram showing an exemplary network configuration in which multicast video streams are selectively delivered;

FIG. 8 is a schematic diagram of networks in which multicast video streams are selectively delivered;

FIG. 9 is a diagram showing a network configuration in which multicast video streams are delivered via a WAN;

FIG. 10 is a schematic diagram of networks in which multicast video streams are delivered via a WAN;

FIG. 11 is a diagram showing a network configuration in which only requested video streams are selected and delivered;

FIG. 12 is a schematic diagram of networks in which only requested video streams are selected and delivered;

FIG. 13 is a diagram showing a network configuration in which video streams selected according to sources of encoding are delivered;

FIG. 14 is a schematic diagram of networks in which video streams selected according to sources of encoding are delivered;

FIG. 15 is a diagram showing an exemplary configuration of a network system having video selection servers connected in multiple stages;

FIG. 16 is a diagram showing an exemplary multi-stage configuration of parallel-connected video selection servers; and

FIG. 17 is a diagram showing an exemplary network configuration in which video bandwidth is restricted according to video types.

### DESCRIPTION OF THE PREFERRED EMBODIMENTS

Embodiments of the present invention will be hereinafter described with reference to the drawings.

First, the invention applied to embodiments will be outlined, and then specific embodiments of the invention will be described.

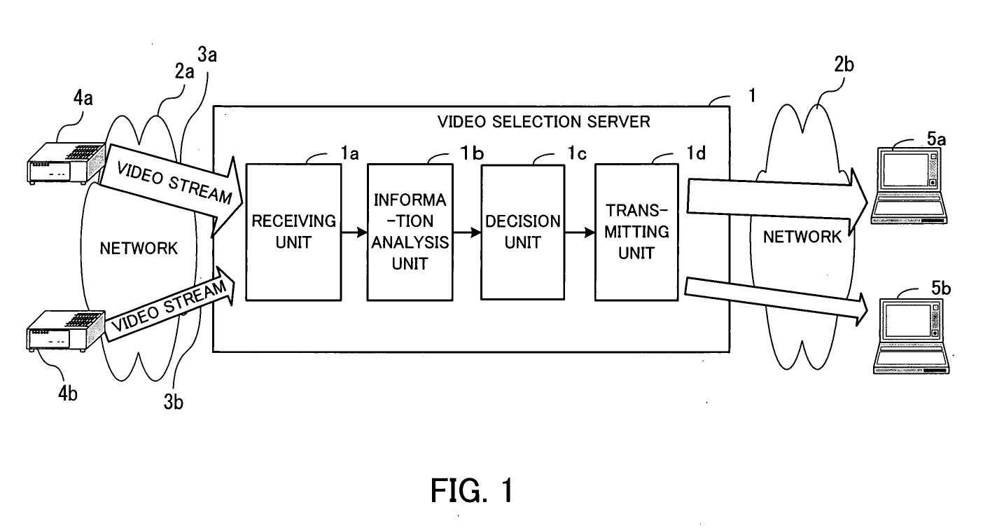

FIG. 1 is a conceptual diagram illustrating the invention applied to the embodiments. A video selection server 1 comprises a receiving unit 1a, an information analysis unit 1b, a decision unit 1c and a transmitting unit 1d, in order to selectively relay video information.

The receiving unit 1a receives video streams 3a, 3b delivered via a first network 2a. For example, the receiving unit 1a receives the video streams 3a and 3b which have been encoded by encoders 4a and 4b, respectively, and broadcast over the first network 2a.

The information analysis unit 1b analyzes information about the video streams 3a and 3b received by the receiving unit 1a. For example, information such as the transmission protocols (multicast, unicast, etc.), compression/encoding schemes, video contents or the like of the video streams 3a and 3b is analyzed.

The decision unit 1c determines whether or not the result of analysis by the information analysis unit 1b fulfills a predetermined criterion, to judge whether to permit delivery of the video streams 3a and 3b received by the receiving unit 1a to a second network 2b (filtering). For example, in the case where the second network 2b has a smaller transmission capacity (narrower bandwidth) than the first network 2a, delivery of a video stream to the second network 2b is permitted if the video stream has been encoded using an encoding scheme that provides high compression rate. Also, in the case where the first network 2a is an intranet and the second network 2b is the Internet, delivery of a video stream to the second network 2b is permitted if it is previously judged that the contents of the video stream may be laid open to the public. Alternatively, delivery to the second network 2b may be permitted for only a video stream with respect to which delivery has been requested by any of clients 5a, 5b.

The transmitting unit id transmits, to the second network 2b, the video stream of which the delivery has been permitted by the decision unit 1c. For example, the transmitting unit 1d unicasts a video stream to the clients 5a, 5b which have requested delivery of the video stream. Where more clients than a predetermined number have requested delivery of an identical video stream, the video stream may be delivered by multicast.

With the video selection server 1, only information streams that satisfy the predetermined criterion among the video streams 3a, 3b delivered over the first network 2a are transmitted to the second network 2b. As a result, it is possible to prevent unnecessary video streams from being delivered to the second network 2b and thus to lighten the traffic load on the second network 2b.

Namely, in a large-scale network, video streams from multiple encoders are delivered over the network. If such video streams are always delivered to another network connected through a router etc., the data transmission capability (bandwidth) of the other network is consumed uselessly.

Thus, the video selection server 1 of the present invention is interposed between encoders and clients, whereby video streams from multiple encoders can be delivered to multiple clients without uselessly consuming the bandwidth. Since the video selection server 1 is capable of filtering according to the transmission protocol, encoding scheme, contents of video, etc., more elaborate control than that achieved by conventional systems can be carried out. For example, video which the user desires among multiple video streams can be transmitted at a desired transmission rate without delay.

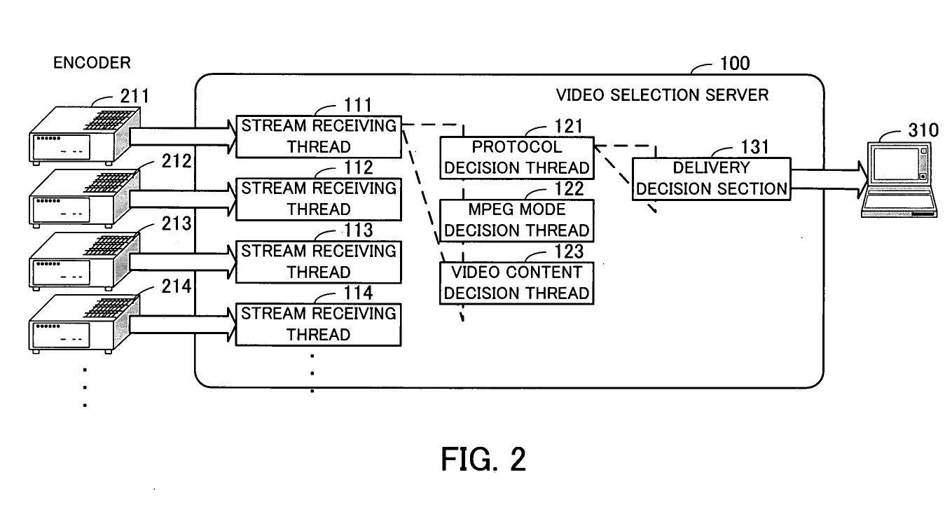

FIG. 2 shows an exemplary configuration of the video selection server. The video selection server 100 is connected with a plurality of encoders 211, 212, 213, 214, . . . and is input with a video stream from each of the encoders 211, 212, 213, 214, . . . . The video selection server 100 selects a video stream requested by a client 310 and transmits the selected video stream to the client 310.

The video selection server 100 includes a plurality of stream receiving threads 111, 112, 113, 114, . . . , a protocol decision thread 121, an MPEG (Motion Picture Experts Group) mode decision thread 122, a video content decision thread 123, and a delivery decision section 131.

In the illustrated example, there are prepared as many stream receiving threads 111, 112, 113, 114, . . . as the video streams to be input so that multiple streams can be simultaneously processed. Each of the stream receiving threads 111, 112, 113, 114, . . . transfers the received video stream to the individual decision threads. At this time, if the video stream contains high image quality data and low image quality data, the stream is separated into the respective video streams, which are then transferred to the individual decision threads.

The decision threads are prepared for respective filtering criteria. In the example of FIG. 2, the protocol decision thread 121, the MPEG mode decision thread 122 and the video content decision thread 123 are provided. The protocol decision thread 121 analyzes information in the video stream to determine a communication protocol thereof. For example, whether the protocol used is multicast or unicast is determined. The MPEG mode decision thread 122 analyzes information in the video stream to determine a type of compression/encoding scheme according to MPEG. For example, compression type such as MPEG1, MPEG2 or MPEG4 is determined. The video content decision thread 123 analyzes information in the video stream to determine the contents of the video. For example, the video content may be determined on the basis of scene description content conformable to MPEG7. After these determinations are made, the video stream is transferred to the delivery decision section 131.

The delivery decision section 131 checks a request from the client 310 and transmits a video stream complying with the request to the client 310. The delivery decision section 131 may also be set so as to act as a Push-type system whereby the video stream can be delivered to the external network even in the absence of a request from the client 310.

The configuration described above permits only the video stream which the client 310 requires among multiple video streams to be delivered to the client 310.

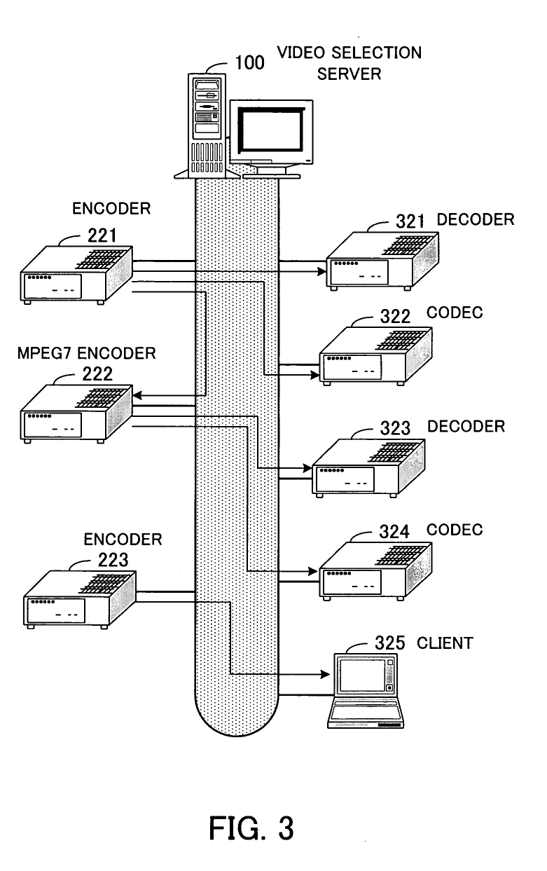

FIG. 3 illustrates an example of video stream transfer via the video selection server. In the example of FIG. 3, the video selection server 100 is connected with an encoder 221, an MPEG7 encoder 222, an encoder 223, a decoder 321, a codec 322, a decoder 323, a codec 324, and a client 325. The receiving-side devices each make a request to the video selection server 100 for delivery of a certain kind of video stream. The video selection server 100 acquires a video stream sent from each of the video stream-transmitting devices, selects a device which has requested delivery of the video stream, and transmits the video stream to the selected device.

In the example of FIG. 3, the video stream sent from the encoder 221 is transmitted to the MPEG7 encoder 222, the decoder 321 and the codec 322. The video stream sent from the MPEG7 encoder 222 is transmitted to the decoder 323 and the codec 324, and the video stream sent from the encoder 223 is transmitted to the client 325.

In this manner, video streams can be distributed by the intervening video selection server 100 of the present invention.

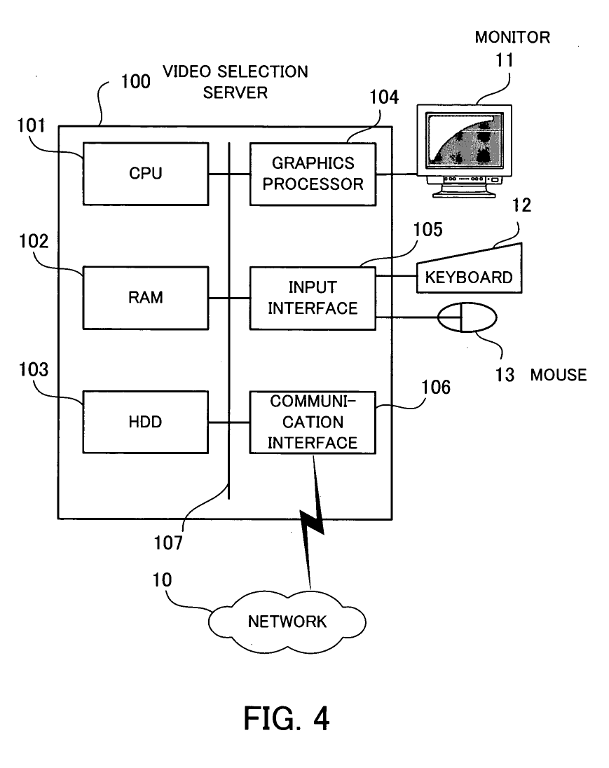

FIG. 4 shows an exemplary hardware configuration of the video selection server used in the embodiments of the present invention. The video selection server 100 is in its entirety under the control of a CPU (Central Processing Unit) 101. The CPU 101 is connected, via a bus 107, with a RAM (Random Access Memory) 102, a hard disk drive (HDD) 103, a graphics processor 104, an input interface 105, and a communication interface 106.

The RAM 102 temporarily stores OS (Operating System) programs executed by the CPU 101 and at least part of application programs. Also, the RAM 102 stores various data necessary for the processing by the CPU 101. The HDD 103 stores the OS and application programs.

The graphics processor 104 is connected with a monitor 11. In accordance with instructions from the CPU 101, the graphics processor 104 displays images on the screen of the monitor 11. The input interface 105 is connected with a keyboard 12 and a mouse 13. The input interface 105 sends signals from the keyboard 12 and the mouse 13 to the CPU 101 via the bus 107.

The communication interface 106 is connected to a network 10 and transmits/receives data to/from other video selection servers through the network 10.

Processing functions of the embodiments can be performed by the hardware configuration described above.

The video selection server 100 can receive a flow of video stream containing videos of different image qualities, and can separate the received video stream into multiple video streams of respective different image qualities.

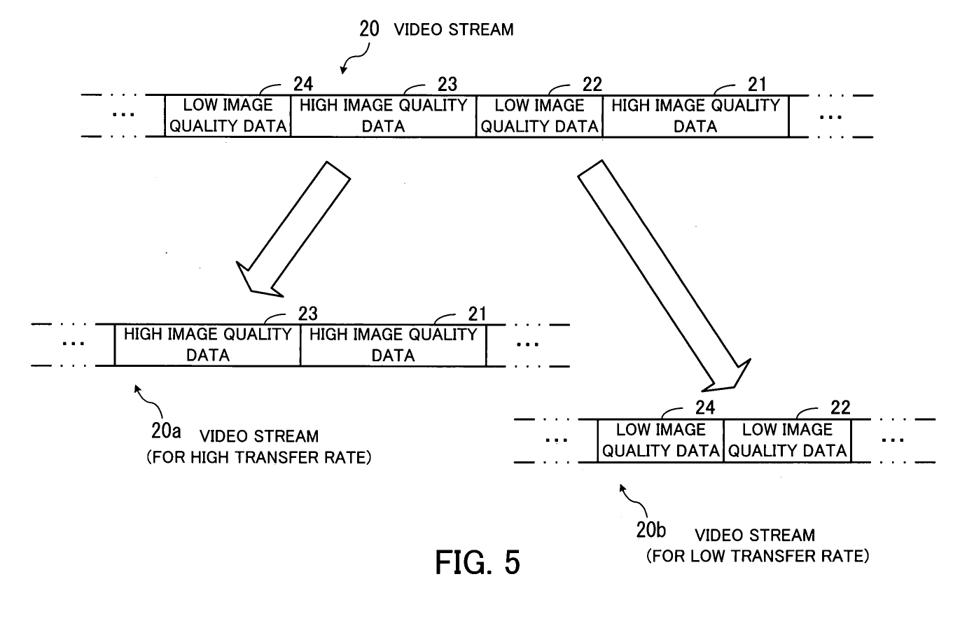

FIG. 5 is a conceptual diagram illustrating the manner of separating a video stream. As shown in FIG. 5, a video stream 20 contains high image quality data 21, 23, . . . and low image quality data 22, 24, . . . . The high image quality data 21, 23, . . . constitute a video stream of high image quality, and the low image quality data 22, 24, . . . constitute a video stream of lower image quality than that of the video stream constituted by the high image quality data 21, 23 . . . .

The image quality of a video stream is dependent, for example, on the resolution of the screen, the number of frames per second, etc. In the case of a high image quality video stream, a larger amount of data needs to be transferred per unit time than in the case of a low image quality video stream.

A video stream for transferring a motion picture of single image quality at times includes, in a packet thereof, a data area which can be used by the user as desired. In such cases, the low image quality data 22, 24, . . . constituting the low image quality video stream may be stored in the data areas available to the user, whereby the video stream 20 containing the high and low image quality video streams can be generated without increasing the total number of packets to be transferred.

The video stream 20 is separated by one of the stream receiving threads 111, 112, 113, 114, . . . into a video stream 20a for high transfer rate and a video stream 20b for low transfer rate. Consequently, the video streams of high and low image qualities can be delivered to separate devices.

Also, where the video selection server 100 is connected between an intranet and the Internet, only the video streams that satisfy the predetermined criteria among those delivered within the intranet can be delivered to clients on the Internet.

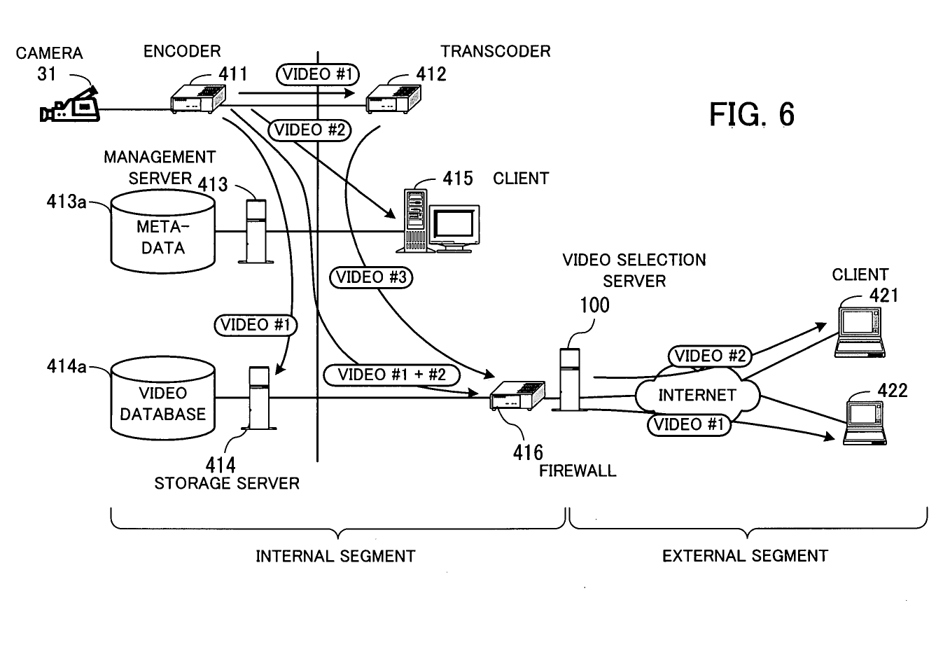

FIG. 6 shows an example of information delivery through the video selection server. In the example shown in FIG. 6, the video selection server 100 is connected between an intranet as an internal segment and the Internet as an external segment.

In the internal segment, image captured by a camera 31 is input to an encoder 411. The encoder 411 is connected through the network to a transcoder 412, a management server 413, a storage server 414, a client 415, and a firewall 416. The encoder 411 compresses/encodes the image input from the camera 31 and delivers video streams showing the input image to the devices connected via the network. For example, a video stream “VIDEO #1” is delivered to the transcoder 412 and the storage server 414, and a video stream “VIDEO #2” is delivered to the client 415. Also, a video stream containing both “VIDEO #1” and “VIDEO #2” is delivered to the firewall 416.

The transcoder 412 changes the data format of the video stream received from the encoder 411 and delivers the resultant data to other devices. For example, the transcoder 412 translates an MPEG2 video stream to an MPEG4 video stream and delivers the resultant video stream to other devices. In the example of FIG. 6, a video stream “VIDEO #3”obtained through the translation from “VIDEO #1” is delivered to the firewall 416. The video stream delivery from the transcoder 412 is suited for delivery of live video.

The management server 413 manages meta-data 413a. In the meta-data 413a is defined information about the contents of video streams. For example, the defined information indicates where a video begins and how many seconds the video lasts. The meta-data 413a can be referred to by the video content decision thread 123 in the video selection server 100, and thus the thread 123 can analyze the contents of each video stream on the basis of the meta-data 413a.

The storage server 414 stores video contents in a video database 414a and manages the stored video contents. For example, the storage server 414 receives the video stream “VIDEO #1” encoded by the encoder 411, and stores the received video stream in the video database 414a as a video content. In response to a request from a device, the storage server 414 assembles video content stored in the video database 414a into packets and delivers the packets as a video stream. The video stream delivery from the storage server 414 is suited for provision of VOD (Video On Demand) services.

The client 415 is a client computer connected to the intranet, namely, the internal segment. The client 415 is capable of receiving a video stream delivered through the network and displaying the video. For example, the client 415 receives the video stream “VIDEO #2”from the encoder 411 and displays the video.

The firewall 416 is a device for preventing unauthorized access to the devices within the intranet via the Internet. The firewall 416 allows passage of only those packets which are permitted beforehand to pass therethrough from the internal segment to the external segment and vice versa. In the example of FIG. 6, the firewall 416 is connected to the Internet via the video selection server 100.

The video selection server 100 selects video streams which can be acquired from the devices within the internal segment, and delivers the selected video streams to clients 421, 422 connected through the Internet. Criteria on the basis of which the video selection server 100 selects video streams include, for example, protocol type (multicast or unicast), compression scheme type (MPEG1, MPEG2, MPEG4, etc.), and contents of video (MPEG7-compliant scene description content in the meta-data 413a, etc).

The video selection server 100 is input with multiple videos delivered within the internal segment, and because of the limitation on bandwidth and the security problem, it is not desirable to deliver the videos directly to the external segment. Accordingly, the video selection server 100 selects and delivers videos so that the bandwidth can be optimized.

Also, the video selection server 100 is capable of separating a video stream containing multiple videos into respective video streams and delivering the separated video streams to the clients 421, 422. For example, the video selection server 100 can separate a video stream containing “VIDEO #1” and “VIDEO #2”into separate video streams “VIDEO #1” and “VIDEO #2”and deliver these video streams.

The following describes exemplary network configurations wherein the video bandwidth is optimized by using the video selection server 100.

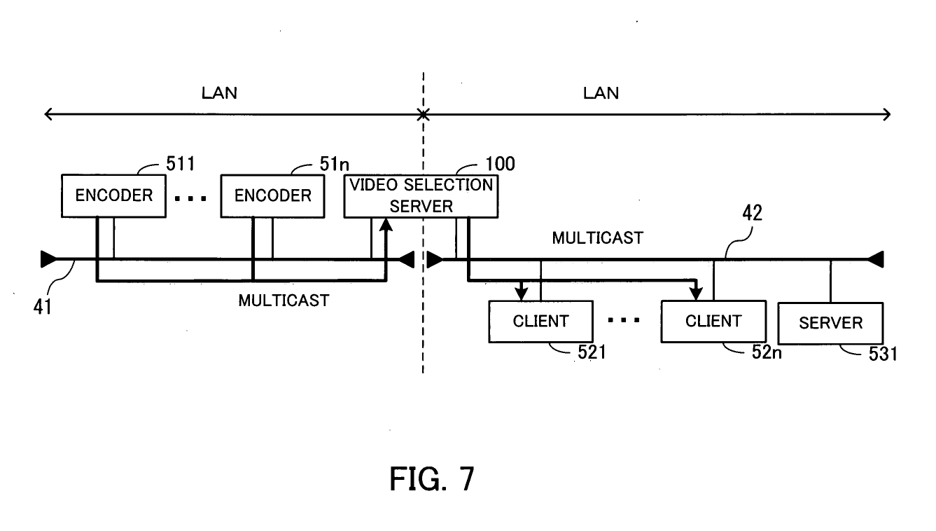

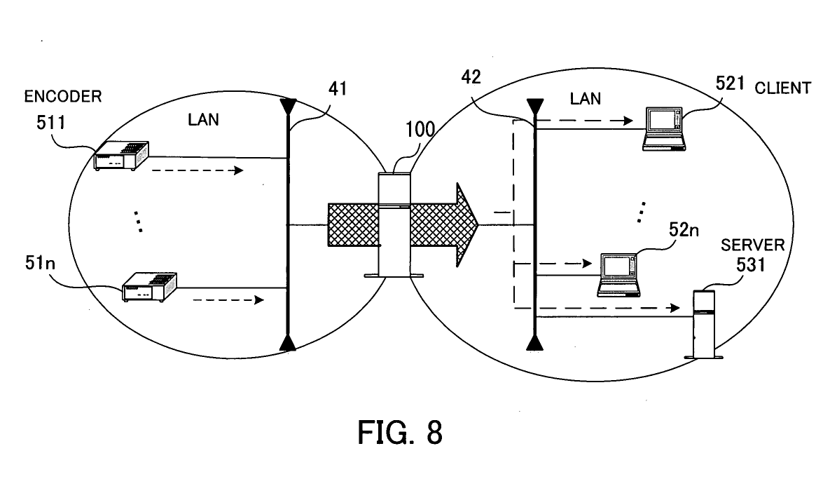

First, referring to FIGS. 7 and 8, an exemplary case will be explained where at least part of multiple video streams multicast within one segment are multicast to another segment.

FIG. 7 shows a network configuration in which multicast video streams are selectively delivered, and FIG. 8 is a schematic diagram of networks in which multicast video streams are selectively delivered. In this instance, the transmission protocol is referred to in order to optimize the video bandwidth.

In the example shown in FIGS. 7 and 8, the video selection server 100 is connected between two LANs (Local Area Networks) 41 and 42 of different segments. A plurality of encoders 511, . . . , 51n are connected to the LAN 41, and a plurality of clients 521, . . . , 52n and a server 531 are connected to the LAN 42.

In the network system configured in this manner, video streams are multicast from the multiple encoders 511, . . . , 51n onto the LAN 41 and are received by the video selection server 100. The video selection server 100 selects only those video streams which are requested by any of the clients 521, . . . , 52n and the server 531, and multicasts the selected video streams onto the LAN 42.

It is therefore possible to prevent unnecessary video streams from being sent to the LAN 42 and thus to optimize the video bandwidth. Usually, multicasts have Class D addresses. Accordingly, if a multicast video stream is transferred not by way of the video selection server 100 to a different network segment, address duplication may possibly occur. However, by transferring a multicast video stream via the video selection server 100 from one segment (LAN 41) to the other (LAN 42), as shown in FIGS. 7 and 8, it is possible to prevent the duplication of multicast address from occurring in the LAN 42, thereby eliminating the address duplication problem.

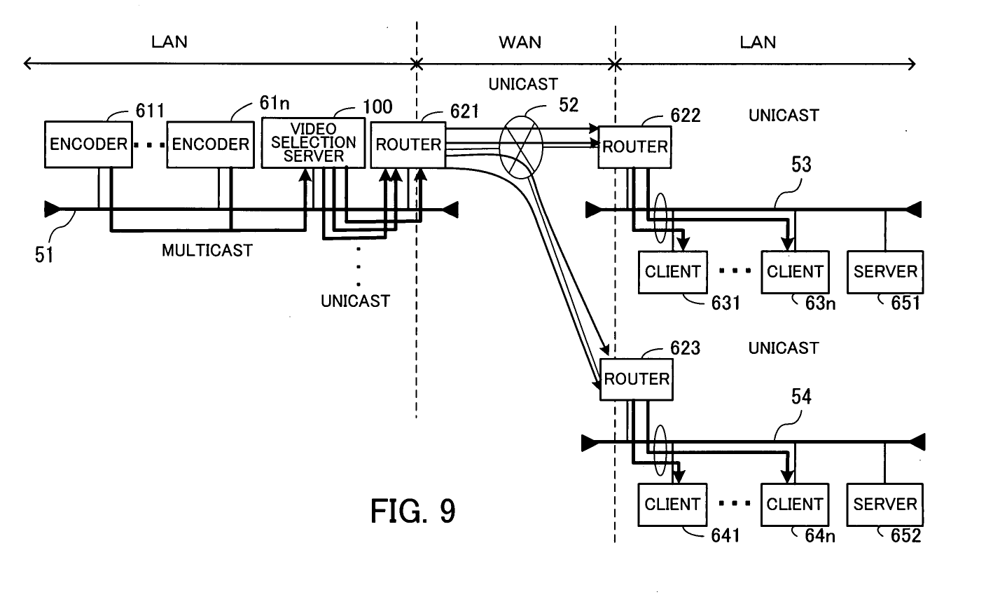

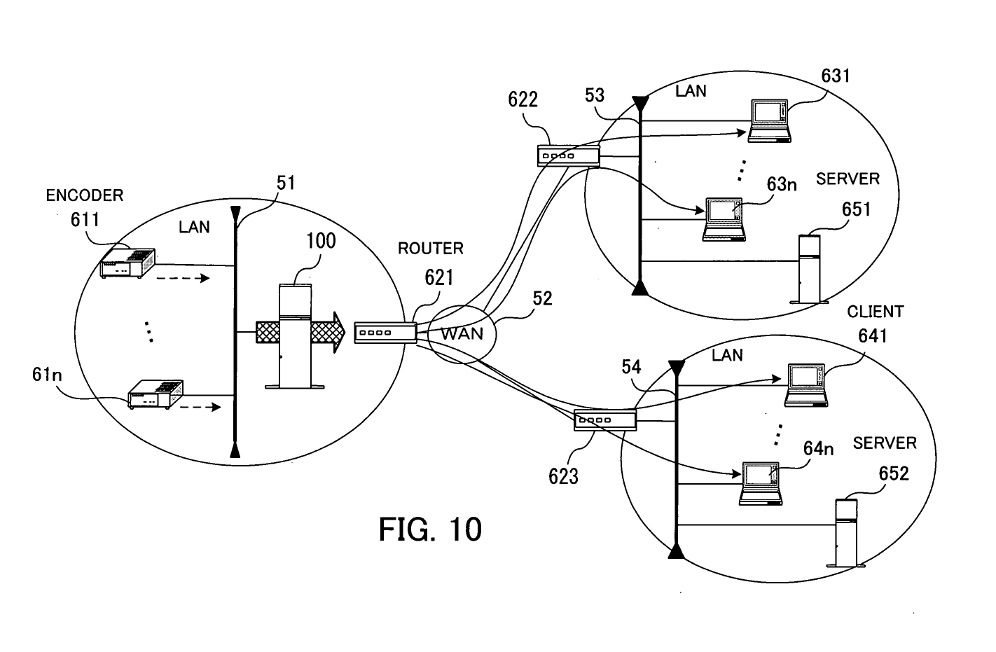

Referring now to FIGS. 9 and 10, an exemplary case will be explained where the video bandwidth is optimized for video streams which are transferred between networks connected via a WAN (Wide Area Network).

FIG. 9 shows a network configuration in which multicast video streams are delivered via a WAN, and FIG. 10 is a schematic diagram of networks in which multicast video streams are delivered via a WAN. In this instance, the transmission protocol is referred to so as to optimize the video bandwidth.

In FIGS. 9 and 10, three LANs 51, 53 and 54 of different segments are interconnected via a WAN 52. To the LAN 51 are connected a plurality of encoders 611, . . . , 61n, the video selection server 100, and a router 621. The router 621 is connected to the WAN 52 and routes packets between the LAN 51 and the WAN 52. A plurality of clients 631, . . . , 63n, a router 622 and a server 651 are connected to the LAN 53. The router 622 is connected to the WAN 52 and serves to route packets between the LAN 53 and the WAN 52. To the LAN 54 are connected a plurality of clients 641, . . . , 64n, a router 623, and a server 652. The router 623 is connected to the WAN 52 and routes packets between the LAN 54 and the WAN 52.

In the network system configured in this manner, video streams are multicast from the respective encoders 611, . . . , 61n on the LAN 51 and received by the video selection server 100. The video selection server 100 selects a video stream requested by any of the clients 631, . . . , 63n and transmits the selected video stream by unicast. The video stream transmitted from the video selection server 100 is output to the WAN 52 by the router 621. The unicast video stream is then input to the router 622 or 623 via the WAN 52, and the router 622 or 623 delivers the video stream to the client specified by the unicast address.

In this manner, only necessary videos can be selected by the video selection server from among a plurality of video streams multicast from the respective encoders and also can be delivered to clients with the transmission protocol converted to unicast.

By using this technique, it is possible to deliver multicast video streams to clients connected via the Internet. Namely, ordinary multicast packets cannot be sent out onto the Internet, but where the protocol is converted to unicast by the video selection server 100 as shown in FIGS. 9 and 10, multicast packets can be delivered via the Internet.

Also, the network bandwidth for outgoing data is in general limited, but by delivering only necessary videos to outside by means of the video selection server 100, it is possible to efficiently use the limited bandwidth.

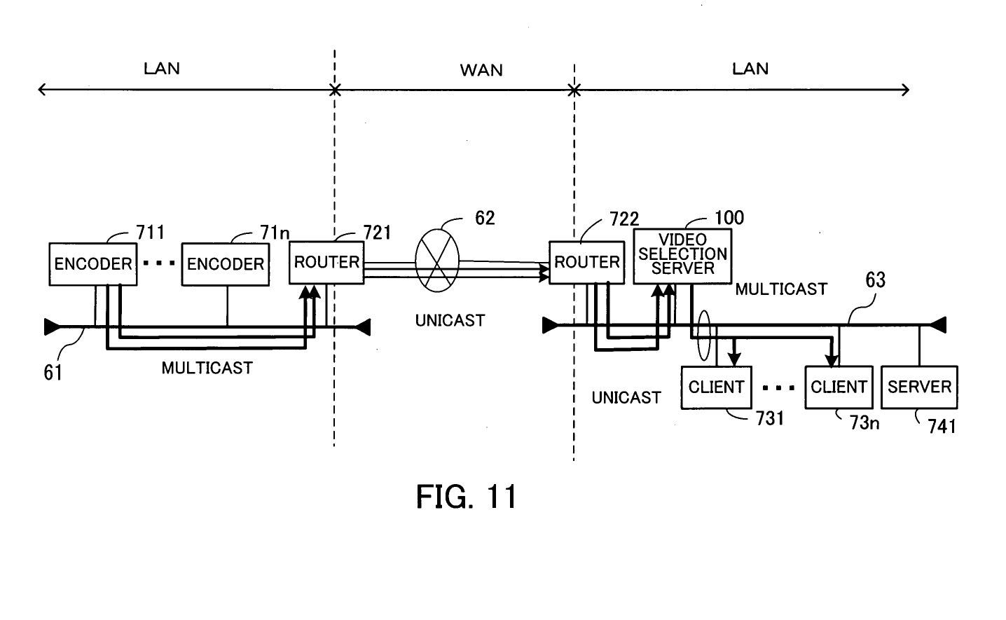

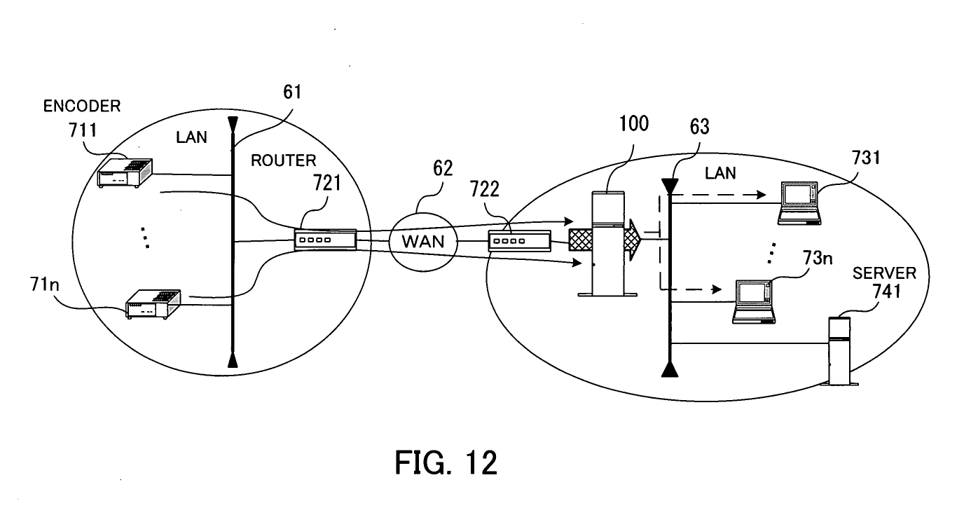

Referring now to FIGS. 11 and 12, an exemplary case will be explained where the video bandwidth is optimized by multicasting only requested video streams.

FIG. 11 shows a network configuration in which only requested video streams are selected and delivered, and FIG. 12 is a schematic diagram of networks in which only requested video streams are selected and delivered. In this example, only a video stream requested by clients is multicast thereby to optimize the video bandwidth.

In FIGS. 11 and 12, two LANs 61 and 63 of different segments are connected via a WAN 62. To the LAN 61 are connected a plurality of encoders 711, . . . , 71n and a router 721. The router 721 is connected to the WAN 62 and routes packets between the LAN 61 and the WAN 62. To the LAN 63 are connected the video selection server 100, a plurality of clients 731, . . . , 73n, a router 722, and a server 741. The video selection server 100 is connected to the WAN 62 through the router 722, and the router 722 routes packets between the video selection server 100 and the WAN 62.

In this network system, video streams are unicast from the respective encoders 711, . . . , 71n. The video streams are output to the WAN 62 through the router 721 and then transferred to the video selection server 100 through the router 722. The video selection server 100 selects a video stream requested by the clients 731, . . . , 73n, from among the input video streams, and multicasts the selected video stream onto the LAN 63, whereupon the clients 731, . . . , 73n receive the delivered video stream and reproduce the video.

In this manner, only necessary video streams are selected by the video selection server, from among the multiple video streams unicast from the respective encoders, and are multicast to the clients with the protocol converted to multicast. It is therefore possible, for example, to select only the video stream generated by a certain encoder and to multicast the selected video stream onto the LAN 63. Since a video stream to be delivered to multiple clients can be multicast, the amount of packets can be reduced compared with the case where the video stream is unicast to the individual clients, whereby the video bandwidth can be optimized.

The delivery mode of the video selection server 100 may be automatically switched from unicast to multicast such that, when the number of clients requesting a video stream is small, the video stream is unicast from the video selection server 100 to the individual clients, and that, when the number of clients requesting the same video stream is larger than a predetermined number, the video stream is multicast to the respective clients, that is, Push-type video delivery is carried out.

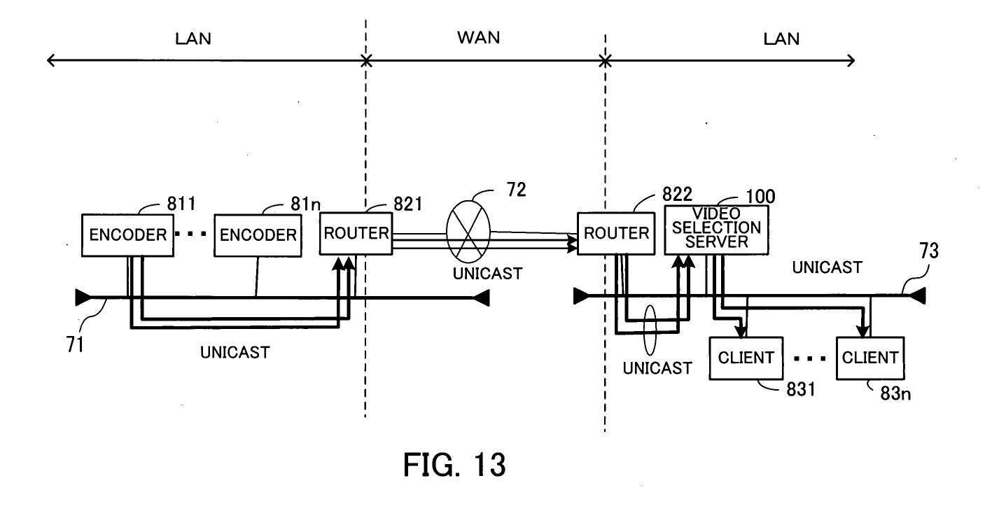

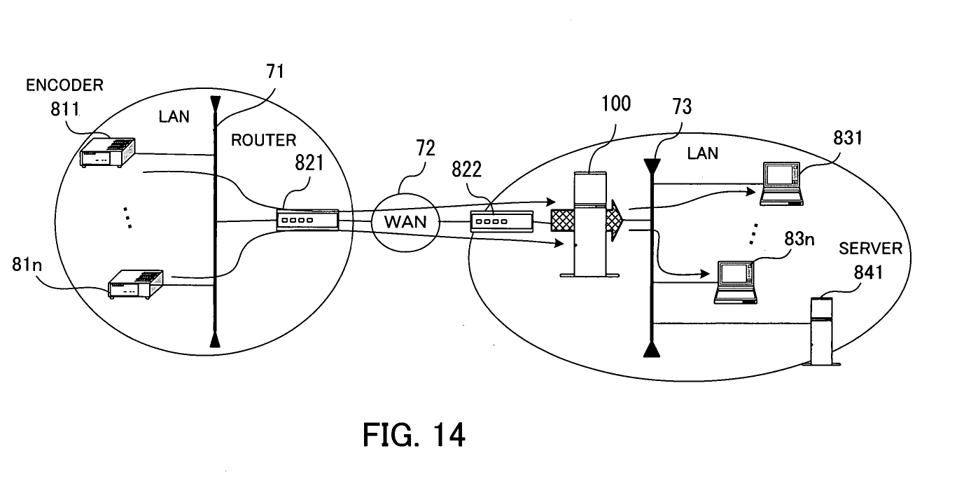

FIG. 13 shows a network configuration in which video streams selected according to sources of encoding are delivered, and FIG. 14 is a schematic diagram of networks in which video streams selected according to sources of encoding are delivered. In this example, a video stream selected according to the source of encoding (encoder) is unicast thereby to optimize the video bandwidth.

In FIGS. 13 and 14, two LANs 71 and 73 of different segments are connected via a WAN 72. To the LAN 71 are connected a plurality of encoders 811, . . . , 81n, and a router 821. The router 821 is connected to the WAN 72 and routes packets between the LAN 71 and the WAN 72. The LAN 73 is connected with the video selection server 100, a plurality of clients 831, . . . , 83n, a router 822, and a server 841. The video selection server 100 is connected to the WAN 72 through the router 822, and the router 822 routes packets between the video selection server 100 and the WAN 72.

In the network system configured as above, video streams are unicast from the respective encoders 811, 81n. The video streams are output to the WAN 72 through the router 821 and are transferred to the video selection server 100 through the router 822. The video selection server 100 selects a video stream output from a predetermined encoder, from among the input video streams. Then, the video selection server 100 unicasts the selected video stream to the clients 831, . . . , 83n requesting the video stream, whereupon the clients 831, . . . , 83n receive the delivered video stream and reproduce the video.

Thus, only necessary videos can be selected by the video selection server, from among the multiple video streams unicast from the encoders, and can be delivered to the clients. In this case, the requests from the clients are not transferred to the WAN 72, and it is therefore possible to prevent unnecessary increase in the traffic of the WAN 72.

In the aforementioned exemplary configurations of network systems, only one video selection server is used, but multiple video selection servers may be connected in stages instead.

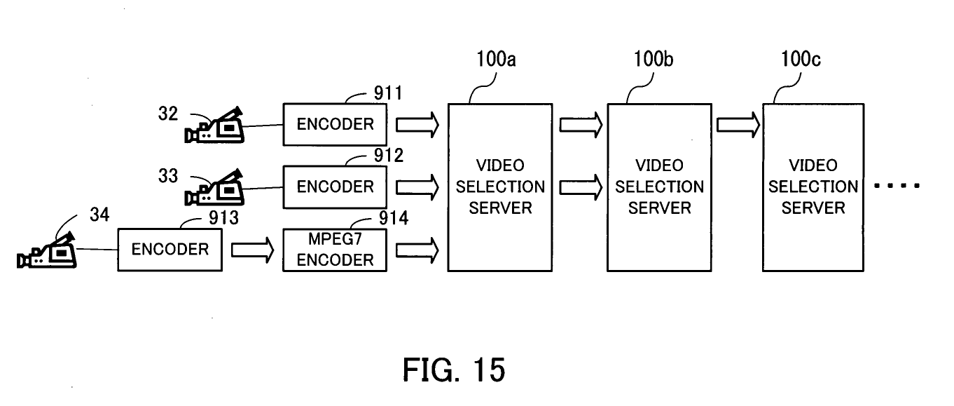

FIG. 15 shows an exemplary configuration of a network system including video selection servers connected in multiple stages. In the example of FIG. 15, video captured by a camera 32 is encoded by an encoder 911 and transferred to a video selection server 100a as a video stream. Also, video captured by a camera 33 is encoded by an encoder 912 and transferred to the video selection server 100a as a video stream. Video captured by a camera 34 is encoded by an encoder 913 and transferred to an MPEG7 encoder 914 as a video stream. After creating meta-data etc., the MPEG7 encoder 914 transfers the video stream to the video selection server 100a.

In accordance with the contents etc. of the video streams, the video selection server 100a transmits only the video streams requested by its subordinate devices to a video selection server 100b. Similarly, in accordance with the contents etc. of the video streams, the video selection server 100b transmits only the video stream requested by its subordinate devices to a video selection server 100c. The video selection servers 100a, 100b and 100c are arranged in LANs of respective different segments and can multicast video streams to the clients belonging to the respective segments. Also, video streams may be unicast between the video selection servers 100a, 100b and 100c so that the video streams can be delivered via the Internet intervening between the servers.

There is no limit on the number of stages of the video selections servers, and thus the video selection server 100c may be connected with subordinate video selection servers.

In this manner, the video selection servers are connected in multiple stages, and each video selection server performs the necessary filtering on multiple video streams input thereto and transmits the results to the succeeding-stage network, whereby the traffic of the succeeding-stage network can be mitigated.

In the example of FIG. 15, the video selection servers are sequentially connected in stages but may alternatively be parallel-connected in stages.

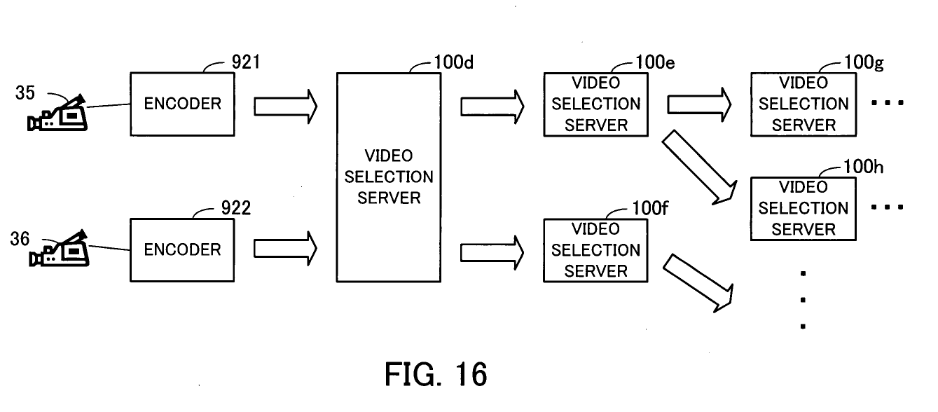

FIG. 16 shows an exemplary multi-stage configuration of parallel-connected video selection servers. In the example of FIG. 16, video captured by a camera 35 is encoded by an encoder 921 and transferred to a video selection server 100d as a video stream. Also, video captured by a camera 36 is encoded by an encoder 922 and transferred to the video selection server 100d as a video stream.

In accordance with the contents etc. of the video streams, the video selection server 100d transmits only the video streams requested by its subordinate devices to a video selection server 100e or 100f. Similarly, in accordance with the contents etc. of the video streams, the video selection server 100e transmits only the video streams requested by its subordinate devices to a video selection server 100g or 100h.

Thus, by connecting multiple video selection servers 100e, 100f as subordinate devices (destinations of video streams) to the video selection server 100d, it is possible to transmit a minimum amount of video streams to the transmission path connecting to the video selection server 100e, 100f. This configuration is especially useful in cases where the places of business etc. are dispersed at different locations and are connected to each other by a network with limited bandwidth, such as the Internet.

An exemplary case will be now explained where videos to be delivered are selected according to video types.

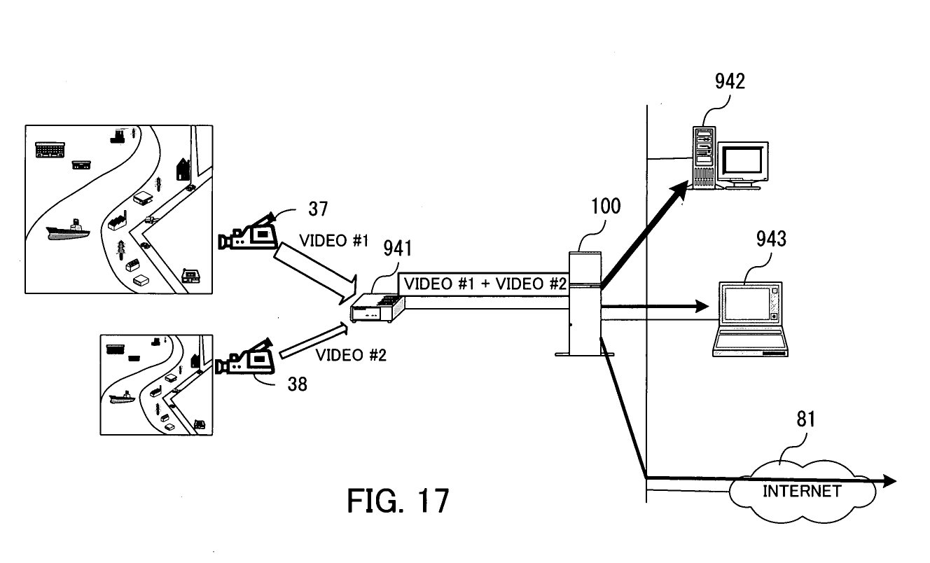

FIG. 17 shows an exemplary network configuration in which video bandwidth is restricted according to video types. In the example of FIG. 17, two cameras 37 and 38 are connected to an encoder 941, which is connected to the video selection server 100. The video selection server 100 is connected to clients 942 and 943, and the Internet 81.

The two cameras 37 and 38 each monitor the conditions of a river, and the camera 37 can capture higher-resolution video than the camera 38. The video captured by the camera 37 is hereinafter referred to as “VIDEO #1”, and the video captured by the camera 38 as “VIDEO #2”. The cameras 37 and 38 transmit the videos captured thereby to the encoder 941. The encoder 941 generates a video stream from the videos sent from the cameras 37 and 38, and transmits the generated video stream to the video selection server 100. At this time, the encoder 941 transmits a single video stream containing “VIDEO #1” and “VIDEO #2”to the video selection server 100.

On receiving the video stream containing “VIDEO #1” and “VIDEO #2”, the video selection server 100 separates the video stream into a video stream “VIDEO #1” and a video stream “VIDEO #2”. Then, in response to a request from the clients 942, 943 or from other devices connected via the Internet 81, the video selection server 100 delivers the video stream “VIDEO #1” or “VIDEO #2”. For example, if the client 942 is a high-performance computer (capable of reproducing high-resolution video), a request for the high-resolution “VIDEO #1” is output from the client 942 and the video stream “VIDEO #1” is unicast to the client 942.

If the client 943 is a low-performance computer (incapable of satisfactorily reproducing high-resolution video), a request for the low-resolution “VIDEO #2”is output from the client 943 and the video stream “VIDEO #2” is unicast to the client 943. Also, if the amount of data of the video stream “VIDEO #1” is too large to be delivered via the Internet 81, the video stream “VIDEO #2” is delivered in response to a request received via the Internet 81.

As described above, according to the embodiments of the present invention, the video selection server transmits only video streams requested by other devices to a downstream-side network (network farther from the encoders etc. for generating the video streams) in accordance with information such as the contents of the video streams, whereby the amount of data transmitted through the downstream-side network can be reduced.

The processing functions described above can be performed by a computer. In this case, a program is prepared in which are described processes for performing the functions of the video selection server. The program is executed by a computer, whereupon the aforementioned processing functions are accomplished by the computer. The program describing the required processes may be recorded on a computer-readable recording medium. The computer-readable recording medium includes a magnetic recording device, an optical disc, a magneto-optical recording medium, a semiconductor memory, etc. The magnetic recording device may be a hard disk drive (HDD), a flexible disk (FD), a magnetic tape or the like. As the optical disc, a DVD (Digital Versatile Disc), a DVD-RAM (Random Access Memory), a CD-ROM (Compact Disc Read Only Memory), a CD-R (Recordable)/RW (ReWritable) or the like may be used. The magneto-optical recording medium includes an MO (Magneto-Optical disc) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer loads the program from its storage device and performs processes in accordance with the program. The computer may load the program directly from the portable recording medium to perform processes in accordance with the program. Also, as the program is transferred from the server computer, the computer may sequentially perform processes in accordance with the received program.

As described above, according to the present invention, only the video stream which fulfills a predetermined criterion among those delivered via a first network is transmitted to a second network, and accordingly, the traffic of the second network can be reduced.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A video selection server for selectively relaying video information, comprising:
receiving means for receiving a video stream delivered via a first network;
information analysis means for analyzing information about the video stream received by the receiving means;
decision means for determining whether or not a result of analysis by the information analysis means fulfills a predetermined criterion, to judge whether to permit delivery of the video stream received by the receiving means to a second network; and
transmitting means for transmitting, to the second network, the video stream of which the delivery to the second network has been permitted by the decision means.

2. The video selection server according to claim 1, wherein the decision means permits the delivery of the video stream for which a request has been output from a device connected to the second network.

3. The video selection server according to claim 2, wherein the receiving means receives the video stream which has been multicast on the first network, and
the transmitting means unicasts the requested video stream to a client which has output the request.

4. The video selection server according to claim 3, wherein, if the request for the video stream has been output from more clients than a predetermined number, the transmitting means delivers the video stream by multicast.

5. The video selection server according to claim 2, wherein the receiving means receives the video stream which has been unicast via the first network, and
the transmitting means delivers the video stream by multicast.

6. The video selection server according to claim 1, wherein the information analysis means analyzes a transmission protocol of the video stream.

7. The video selection server according to claim 1, wherein the information analysis means analyzes an encoding scheme of the video stream.

8. The video selection server according to claim 1, wherein the information analysis means analyzes video contents of the video stream.

9. The video selection server according to claim 1, wherein, if the received video stream contains a plurality of videos, the receiving means separates the received video stream into a plurality of video streams corresponding to the respective videos.

10. A video delivery system for delivering a video stream, comprising:
an encoder for encoding captured video to obtain a video stream and delivering the video stream via a first network; and
a video selection server for receiving the video stream delivered via the first network, analyzing information about the received video stream, determining whether or not a result of the analysis fulfills a predetermined criterion, to judge whether to permit delivery of the received video stream to a second network, and transmitting, to the second network, the video stream of which the delivery to the second network has been permitted.

11. The video delivery system according to claim 10, wherein the video selection server has a multi-stage configuration such that the video stream transmitted from a preceding-stage video selection server is delivered to a succeeding-stage video selection server.

12. The video delivery system according to claim 11, wherein the succeeding-stage video selection server includes a plurality of video selection servers connected to the preceding-stage video selection server.

13. A video selection method for selectively relaying video information, comprising the steps of:
receiving a video stream delivered via a first network;
analyzing information about the received video stream;
determining whether or not a result of the analysis fulfills a predetermined criterion, to judge whether to permit delivery of the received video stream to a second network; and
transmitting, to the second network, the video stream of which the delivery to the second network has been permitted.

14. A video selection program for relaying a video stream, wherein the video selection program causes a computer to perform the process of:
receiving a video stream delivered via a first network;
analyzing information about the received video stream;
determining whether or not a result of the analysis fulfills a predetermined criterion, to judge whether to permit delivery of the received video stream to a second network; and
transmitting, to the second network, the video stream of which the delivery to the second network has been permitted.

15. A computer-readable recording medium recording a video selection program for selectively relaying video information, wherein the video selection program causes the computer to perform the process of:
receiving a video stream delivered via a first network;
analyzing information about the received video stream;
determining whether or not a result of the analysis fulfills a predetermined criterion, to judge whether to permit delivery of the received video stream to a second network; and
transmitting, to the second network, the video stream of which the delivery to the second network has been permitted.
